(19) United States
(12) Patent Application Publication
(10) Pub. No.: US 2020/0004073 A1
(43) Pub. Date: Jan. 2, 2020

(54) LIQUID CRYSTAL DISPLAY DEVICE

(71) Applicant: SHARP KABUSHIKI KAISHA, Sakai City, Osaka (JP)

(72) Inventors: KUNIAKI OKADA, Sakai City, Osaka (JP); SEIICHI UCHIDA, Sakai City, Osaka (JP)

(21) Appl. No.: 16/493,649

(22) PCT Filed: Mar. 12, 2018
(86) PCT No.: PCT/JP2018/009500

§ 371 Date: Sep. 12, 2019

(30) Foreign Application Priority Data
Mar. 15, 2017 (JP) 2017-050424

(51) Int. Cl. G02F 1/1339; G02F 1/1368; G02F 1/1343; G02F 1/1362; G02F 1/1333

(52) U.S. Cl. CPC G02F 1/13394; G02F 1/1368; G02F 1/134336; G02F 2202/10; G02F 1/133345; G02F 1/13439; G02F 2201/123; G02F 1/136286

(57) ABSTRACT

A liquid crystal display device (100A) includes a TFT substrate (10), a counter substrate (30), and a liquid crystal layer (50). The TFT substrate includes gate bus lines (GL) extending in a first direction and source bus lines (SL) extending in a second direction. The counter substrate includes a plurality of columnar spacers (40) defining a thickness of the liquid crystal layer. A surface of the TFT substrate on the liquid crystal layer side includes a plurality of first projections overlapping a plurality of gate bus lines to extend in the first direction, and protruding on the liquid crystal layer side, and a plurality of second projections overlapping a plurality of source bus lines to extend in the second direction and protruding toward the liquid crystal layer. The plurality of columnar spacers include a first columnar spacer (40a) supporting at least two projections among the plurality of first projections or at least two projections among the plurality of second projections on a top surface.

### TECHNICAL FIELD

The present invention relates to a liquid crystal display device.

### BACKGROUND ART

Currently, a liquid crystal display device including an active matrix substrate has been used for various applications. In recent years, an active matrix type liquid crystal display device is advanced in high definition. In addition, there is also a growing need to narrow a frame and reduce manufacturing costs.

Generally, the active matrix type liquid crystal display device includes an active matrix substrate, a counter substrate (also referred to as a “color filter substrate”) disposed opposite to the active matrix substrate, and a liquid crystal layer provided between both of the substrates. The active matrix substrate has a switching element, for example, a thin film transistor (TFT), in each pixel. A display region of the liquid crystal display device is defined by a plurality of pixels included in the active matrix substrate.

In general, a thickness of the liquid crystal layer of the liquid crystal display device (also referred to as a “cell gap”) is defined by a spacer disposed between the active matrix substrate and the counter substrate. A method of forming a spacer at a predetermined position by using a photolithography process has been widely adopted with high definition of the liquid crystal display device. The spacer formed in such a way is so-called as a “columnar spacer” or a “photospacer (abbreviated to “PS”)”. For example, as disclosed in PTL1, the columnar spacer is formed on the counter substrate in many cases.

### CITATION LIST

### Patent Literature

PTL 1: Japanese Unexamined Patent Application Publication No. 2008-242035

PTL 2: Japanese Unexamined Patent Application Publication No. 2016-1350

### SUMMARY OF INVENTION

### Technical Problem

When vibration or a force from the outside is applied to the liquid crystal display device, an alignment film of the active matrix substrate may be partially peeled off by the columnar spacer provided on the counter substrate.

Therefore, a display quality may be degraded due to alignment disorder of liquid crystal molecules. In addition, since the vicinity of the columnar spacer is covered with, for example, the light shielding layer (black matrix) provided on the counter substrate, it does not contribute to display. Accordingly, even when the alignment disorder of the liquid crystal molecules occurs in a region covered with the light shielding layer, the display quality is hardly influenced. However, when the vibration or the force from the outside is applied at the time of transportation of the liquid crystal display device, peeling-off of the alignment film or the alignment disorder of liquid crystal molecules due to the peeling-off may occur in a region not covered with the light shielding layer (that is, a region contributed to display), by deviating a positional relationship between the active matrix substrate and the counter substrate or deflecting the active matrix substrate and/or the counter substrate. In this case, the display quality may be degraded. In order to suppress degradation in the display quality, since an area of the light shielding layer becomes larger than that in the related art when a portion in which the alignment disorder of liquid crystal molecules may occur is covered by the light shielding layer, the opening ratio of the liquid crystal display device is reduced. Specifically, the opening ratio of the high-definition liquid crystal display device is remarkably reduced.

The present invention was made in consideration of the above-described problems, and an object thereof is to provide a liquid crystal display device capable of suppressing degradation in a display quality due to the partially peeling-off of an alignment film by a columnar spacer while suppressing reduction of an opening ratio.

### Solution to Problem

According to an embodiment of the present invention, a liquid crystal display device includes: a TFT substrate; a counter substrate provided opposite to the TFT substrate; a liquid crystal layer provided between the TFT substrate and the counter substrate; and a plurality of pixels arranged in a matrix shape having a plurality of rows and a plurality of columns, in which the TFT substrate includes a TFT provided in each of the plurality of pixels, a plurality of gate bus lines extending in a first direction, and a plurality of source bus lines extending in a second direction different from the first direction, the counter substrate includes a plurality of columnar spacers defining a thickness of the liquid crystal layer, a surface of the TFT substrate on the liquid crystal layer side includes a plurality of first projections overlapping the plurality of gate bus lines to extend in the first direction and protruding toward the liquid crystal layer, and a plurality of second projections overlapping the plurality of source bus lines to extend in the second direction and protruding toward the liquid crystal layer, and the plurality of columnar spacers include a first columnar spacer supporting at least two projections among the plurality of first, projections or at least two projections among the plurality of second projections on a top surface.

In one embodiment, a width of the top surface of the first columnar spacer is larger than a width of a recess formed between mutually adjacent projections among the at least two projections, in a direction perpendicular to a direction in which the at least two projections extend.

In one embodiment, a width of the top surface of the first columnar spacer is larger than a pixel pitch in the plurality of pixels in a direction perpendicular to a direction in which the at least two projections extend.

In one embodiment, the top surface of the first columnar spacer covers the at least two projections in a cross section perpendicular to a direction in which the at least two projections extend.

In one embodiment, the plurality of columnar spacers further includes a second columnar spacer overlapping at least two of the plurality of gate bus lines or at least two of the plurality of source bus lines and not being in contact with the TFT substrate, when viewed from a normal direction of the TFT substrate.

In one embodiment, the TFT substrate includes a substrate, a first conductive layer supported by the substrate and including a gate electrode of the TFT and the plurality of gate bus lines, a second conductive layer supported by the substrate and including a source electrode of the TFT and the plurality of source bus lines, a gate insulating layer formed between the first conductive layer and the second conductive layer, a semiconductor layer of the TFT, an interlayer insulating layer formed on the first conductive layer, the second conductive layer, and the semiconductor layer, a first transparent conductive layer formed on the interlayer insulating layer, an inorganic insulating layer formed on the first transparent conductive layer, and a second transparent conductive layer formed on the inorganic insulating layer, in which the interlayer insulating layer does not include an organic insulating layer.

In one embodiment, the TFT substrate includes the first conductive layer and the second conductive layer in a region overlapping the at least two projections.

In one embodiment, the TFT substrate includes a region not having the interlayer insulating layer between mutually adjacent projections among the at least two projections.

In one embodiment, the TFT substrate further includes a light shielding layer formed on the interlayer insulating layer in a region overlapping the at least two projections.

In one embodiment, the light shielding layer is formed on the second transparent conductive layer so as to be in contact with the second transparent conductive layer.

In one embodiment, the TFT substrate further includes a third conductive layer formed on the interlayer insulating layer in a region overlapping the at least two projections.

In one embodiment, the third conductive layer is formed on the second transparent conductive layer through an insulating layer.

In one embodiment, the first transparent conductive layer includes a pixel electrode provided in each of the plurality of pixels and electrically connected to a drain electrode of the TFT.

In one embodiment, the drain electrode is included in the first transparent conductive layer.

In one embodiment, the semiconductor layer includes an oxide semiconductor.

In one embodiment, the semiconductor layer includes an In-Ga-Zn-O-based semiconductor.

In one embodiment, the In-Ga-Zn-O-based semiconductor includes x crystalline portion.

In one embodiment, the semiconductor layer includes a laminated structure.

### Advantageous Effects of Invention

According to the embodiment of the present invention, there is provided a liquid crystal display device capable of suppressing degradation in a display quality due to the partially peeling-off of an alignment film by a columnar spacer while suppressing reduction of an opening ratio.

### BRIEF DESCRIPTION OF DRAWINGS

FIG. 1 is a cross-sectional view schematically illustrating a liquid crystal display device 100A according to an embodiment of the present invention.

FIG. 2 is a cross-sectional view schematically illustrating a liquid crystal display device 900 of a comparative example.

FIG. 3 is a plan view illustrating an example of a specific structure of the liquid crystal display device 100A.

FIG. 4 is a cross-sectional view illustrating an example of a specific structure of the quid crystal display device 100A and a cross section taken along line A′ in FIG. 3.

FIG. 5 is a cross-sectional view schematically illustrating the liquid crystal display device 100A.

FIG. 6 is a plan view schematically illustrating disposition of a light shielding layer (black matrix.) 32, a color filter layer 33, and a columnar spacer 40 in the liquid crystal display device 100A.

FIG. 7 is a plan view schematically illustrating disposition of a light shielding layer 932, the color filter layer 33, and a columnar spacer 940 of the liquid crystal display device 900 of the comparative example.

FIG. 8 is a cross-sectional view schematically illustrating another liquid crystal display device 100B according to an embodiment of the present invention.

FIG. 9 is a cross-sectional view schematically illustrating still another liquid crystal display device 100C according to an embodiment of the present invention.

FIG. 10 is a cross-sectional view schematically illustrating still another liquid crystal display device 100D according to an embodiment of the present invention and a cross section taken along line B-B′ in FIG. 11.

FIG. 11 is a plan view schematically illustrating the liquid crystal display device 100D.

FIG. 12 is a cross-sectional view schematically illustrating still another liquid crystal display device 100E according to an embodiment of the present invention.

FIG. 13 is a cross-sectional view schematically illustrating still another liquid crystal display device 100F according to an embodiment of the present invention.

FIG. 14 is a plan view schematically illustrating still another liquid crystal display device 100G according to an embodiment of the present invention.

FIG. 15 is a cross-sectional view schematically illustrating the liquid crystal display device 100G.

FIG. 16 is a plan view schematically illustrating another TFT substrate 10A used in the liquid crystal display device according to an embodiment of the present invention.

FIG. 17 is a cross-sectional view of a crystalline silicon TFT 710A and an oxide semiconductor TFT 710B in the TFT substrate 10A.

### DESCRIPTION OF EMBODIMENTS

Hereinafter, a liquid crystal display device according to embodiments of the present invention will be described with reference to the drawings. Note that, the present invention is not limited to the embodiments illustrated below. In the following drawings, constituent elements having substantially the same function are denoted by the same reference numerals, and the description thereof is omitted.

### Embodiment 1

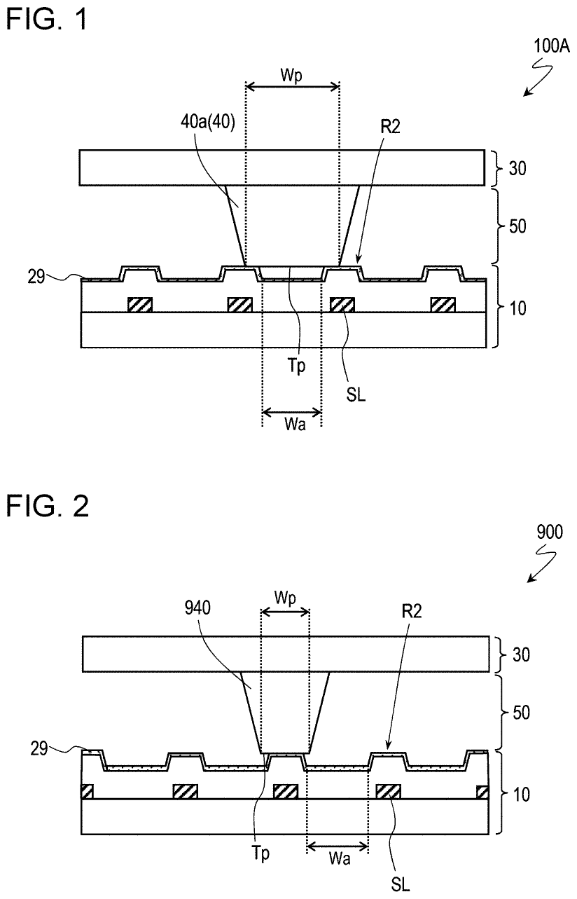

A liquid crystal display device 100A will be described in the present embodiment with reference to FIG. 1. FIG. 1 is a cross-sectional view schematically illustrating the liquid crystal display device 100A.

As illustrated in FIG. 1, the liquid crystal display device 100A includes a TFT substrate 10, a counter substrate (also referred to as “color filter substrate”) 30 provided opposite to the TFT substrate 10, and a liquid crystal layer 50 provided between the TFT substrate 10 and the counter substrate 30. In addition, the liquid crystal display device 100A includes a plurality of pixels arranged in a matrix shape having a plurality of rows and a plurality of columns.

The TFT substrate 10 includes a thin film transistor (TFT; not illustrated) provided in each of the plurality of pixels, a plurality of gate bus lines (scanning lines; not illustrated) extending in a first direction, and a plurality of source bus lines (signal lines) SL extending in a second direction different from the first direction. FIG. 1 illustrates a cross section perpendicular to the second direction.

A surface of the TFT substrate 10 on the liquid crystal layer 50 side includes a plurality of projections R2 (referred to as “second projections R2”) overlapping the plurality of source bus lines SL, to extend in the second direction and protruding toward the liquid crystal layer 50. The surface of the TFT substrate 10 on the liquid crystal layer 50 side further includes a plurality of projections (not illustrated; referred to as “first projections”) overlapping the plurality of gate bus lines to extend in the first direction, and protruding toward the liquid crystal layer 50.

The counter substrate 30 includes a plurality of columnar spacers 40 defining a thickness of the liquid crystal layer 50 (cell gap).

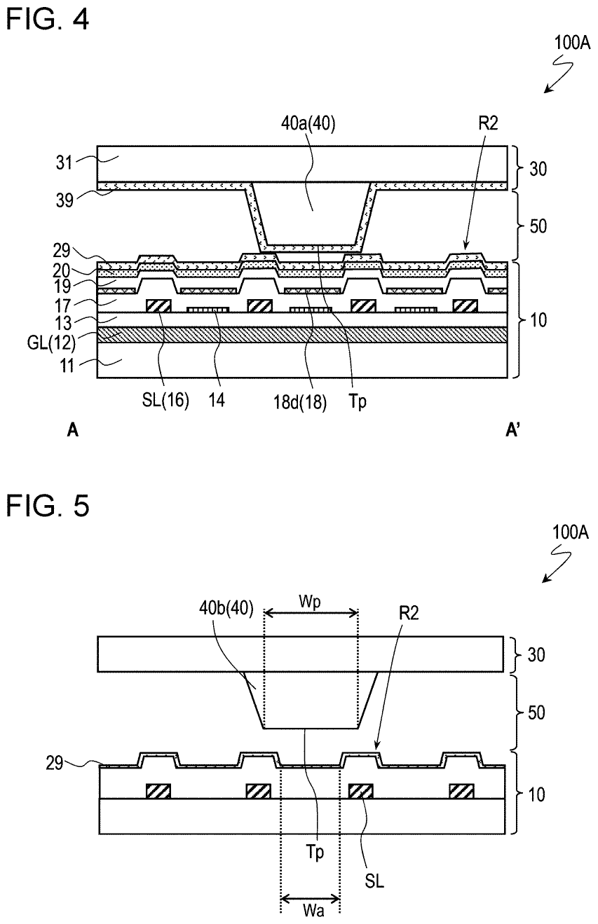

The plurality of columnar spacers 40 include a first columnar spacer 40a supporting at least two projections R2 among the plurality of second projections R2 on a top surface Tp. Here, the first columnar spacer 40a supports two mutually adjacent projections R2 among the plurality of second projections R2 on the top surface Tp. The top surface (top) Tp of the first columnar spacer 40a includes an end of the first columnar spacer 40a on the TFT substrate 10 side. As described later with reference to FIG. 4, the plurality of columnar spacers 40 are covered with an alignment film. The expression “the first columnar spacer 40a supports the projections on the top surface” means that the top surface (top) of the first columnar spacer 40a and the projections are in contact with each other through the alignment film formed to cover the top surface (top) of the first columnar spacer 40a. For the sake of ease, the alignment film of the counter substrate 30 is not illustrated in FIG. 1.

By the configuration above, the liquid crystal display device 100A can suppress degradation in a display quality due to partially peeling-off of the alignment film by the columnar spacer while suppressing reduction of an opening ratio. Hereinafter, the reason will be described with reference to FIG. 2. FIG. 2 is a cross-sectional view schematically illustrating a liquid crystal display device 900 of a comparative example. In FIG. 2, constituent elements having substantially the same as that of the liquid crystal display device 100A are denoted by the same reference numerals, and the description thereof is omitted.

As illustrated in FIG. 2, a columnar spacer 940 of the liquid crystal display device 900 of the comparative example differs from the first columnar spacer 40a of the liquid crystal display device 100A in that the columnar spacer 940 supports one second projection R2 on the top surface Tp.

The columnar spacer 940 provided on the counter substrate 30 is in contact with the TFT substrate 10 at the projection. R2. In the liquid crystal display device 900 of the comparative example, the alignment film 29 formed in a portion other than the projection R2, among the alignment films 29 of the TFT substrate 10, may be partially scraped by the columnar spacer 940. When the alignment film 29 is partially peeled off, for example, vibration or a force from the outside is applied to the liquid crystal display device (for example, at the time of transportation of the liquid crystal display device), this is attributable to (at least temporarily) contact of the columnar spacer 940 with the portion other than the projection R2 by deviating a positional relationship between the TFT substrate 10 and the counter substrate 30 or deflecting she TFT substrate 10 and/or the counter substrate 30. Since the projection R2 overlaps the source bus line SL, although a region overlapping the projection R2 does not contribute to normal display, a region not overlapping the projection R2 includes the region contributed to the display. When the peeling-off of the alignment film 29 or the alignment disorder of liquid crystal molecules due to the peeing-off may occur in the region contributed to the display, the display quality may be degraded. For example, a black display state of the liquid crystal display device performing display in a normally black mode causes light leakage, and thus it is recognized as a bright spot and contrast may be degraded. In order to suppress degradation in the display quality, since an area of the light shielding layer becomes larger than that in the related art when a portion in which the alignment disorder of liquid crystal molecules may occur is covered by the light shielding layer, the opening ratio of the liquid crystal display device is reduced.

The first columnar spacer 40a of the liquid crystal display device 100A of the present embodiment supports at least two projections R2 on the top surface Tp. The first columnar spacer 40a having such a structure is difficult to be in contact with a portion other than the projection R2 in the surface of the TFT substrate 10 on the liquid crystal layer 50 side. For example, even though the positional relationship between the TFT substrate 10 and the counter substrate 30 deviates in a direction perpendicular to the second direction from a state illustrated in FIG. 1 (a lateral direction of FIG. 1), the first columnar spacer 40a is difficult to enter into a recess which is formed between the mutually adjacent projection R2. Accordingly, eh liquid crystal display device 100A, the alignment film 29 partially formed in a portion other than the projection R2, among the alignment films 29 of the TFT substrate 10, is prevented from scraping. Accordingly, degradation in the display quality is suppressed. In order to suppress the degradation in the display quality, it is not necessary that an area of the light shielding layer becomes larger than that of the related art. The liquid crystal display device 100A described above can suppress degradation in the display quality due to partially peeling-off of the alignment film by the columnar spacer, while suppressing reduction of the opening ratio.

PTL 2 discloses a liquid crystal display device capable of suppressing degradation in a display quality due to partially peeling-off of an alignment film by the columnar spacer. The liquid crystal display device of PTL 2 includes a spacer unit in which both an active matrix substrate and a counter substrate include, and constitutes a spacer in which the spacer unit of the active matrix substrate and the spacer unit of the counter substrate define a thickness of the liquid crystal layer. The spacer unit of the active matrix substrate and the spacer unit of the counter substrate extend in mutually different directions, and thus when vibrations or a force from the outside is applied to the liquid crystal display device, scraping, by the spacer unit, of the alignment film formed in the region contributed to the display is suppressed.

However, since the liquid crystal display device of PTL 2 includes the spacer unit in both of the active matrix substrate and the counter substrate, many processes are required for manufacture as compared with the liquid crystal display device 900 of the comparative example, for example. It is advantageous to the liquid crystal display device of PTL 2 in that the liquid crystal display device 100A can suppress degradation in the display quality due to partially peeling-off of the alignment film by the columnar spacer without increasing a manufacturing process, as compared with the liquid crystal display device 900 of the comparative example.

The first columnar spacer 40a of the liquid crystal display device 100A may be formed to satisfy the following conditions, for example. As illustrated in FIG. 1, a width Wp of the top surface Tp of the first columnar spacer 40a may be larger than a width Wa of a recess formed between mutually adjacent projections R2, in a direction perpendicular to a direction to which two projections R2 supported by the first columnar spacer 40a extend (that is, the second direction). If this condition is satisfied, the first columnar spacer 40a can support at least two projections R2 on the top surface Tp. As described above, the first columnar spacer 40a is covered with the alignment film, but a thickness of the alignment film covering the first columnar spacer 40a can be substantially ignored with respect to a size or a shape of the first columnar spacer 40a capable of supporting at least two projections R2 on the top surface Tp. This is because the general thickness of the alignment film is sufficiently small as compared with the width Np of the top surface Tp of the first columnar spacer 40a or the width Na of the recess.

As illustrated in FIG. 2, in the liquid crystal display device 900 of the comparative example, a width Wp of a top surface Tp of the columnar spacer 940 is smaller than the width Na of the recess formed between mutually adjacent projections R2, in a direction perpendicular to the second direction. Accordingly, the columnar spacer 940 supports one projection R2 on the top surface Tp.

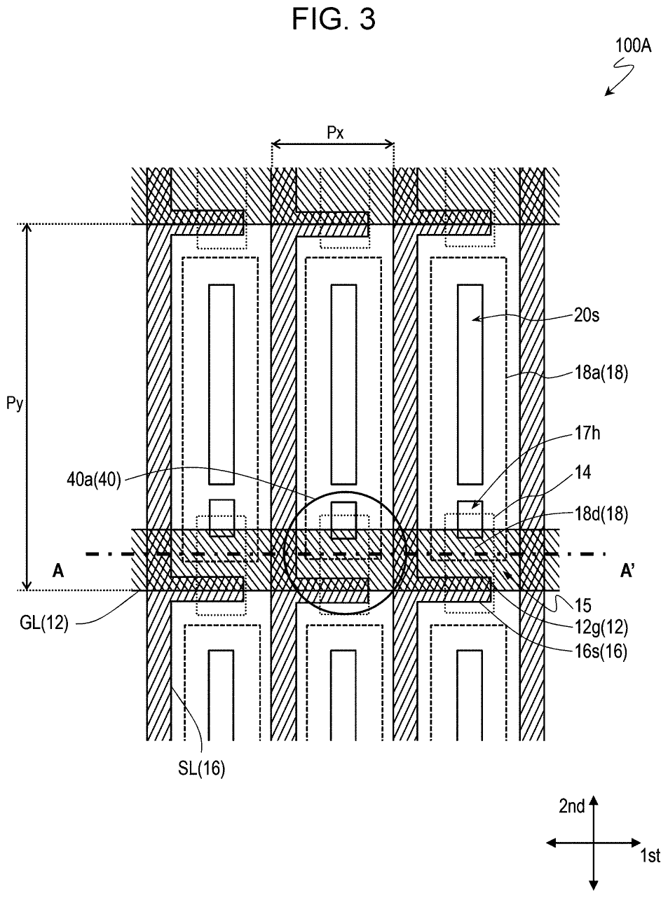

A specific structure of the liquid crystal display device 100A will be described with reference to FIGS. 3 and 4. FIGS. 3 and 4 are a plan view and a cross-sectional view illustrating an example of a specific structure of the liquid crystal display device 100A and FIG. 4 illustrates a cross section taken along line A-A′ in FIG. 3. Here, the liquid crystal display device 100A in the fringe field switching (FFS) mode is illustrated, but a display mode is not limited to the FFS mode. Various known display modes, for example, a twisted sematic (TN) mode, a vertical alignment (VA) mode, and the like, can be used as the display mode.

As illustrated in FIG. 4, the TFT substrate 10 includes a substrate 11, a first conductive layer 12, a gate insulating layer 13, a semiconductor layer 14, a second conductive layer 16, an interlayer insulating layer 17, a first transparent conductive layer 18, an inorganic insulating layer 19, and a second transparent conductive layer 20. The TFT substrate 10 further Includes the alignment film 29 on a surface on the liquid crystal layer 50 side.

As illustrated in FIG. 3, the TFT substrate 10 includes a TFT 15 provided in each of the plurality of pixels, a plurality of gate bus lines GL extending in the first direction, and the plurality of source bus lines SL extending in the second direction. In addition, the TFT substrate 10 has a pixel electrode 18a provided in each of the plurality of pixels.

In the illustrated TFT substrate 10, the first direction of the illustrated TFT substrate 10 is a horizontal direction, and the second direction is a vertical direction. The first and second directions are roughly perpendicular to each other. A plurality of pixels arranged along the first direction is referred to as a pixel row, and a plurality of pixels arranged along the second direction is referred to as a pixel column. The first direction is referred to as a row direction, and the second direction is referred to as a column direction. Note that, the first and second directions are not limited to this example.

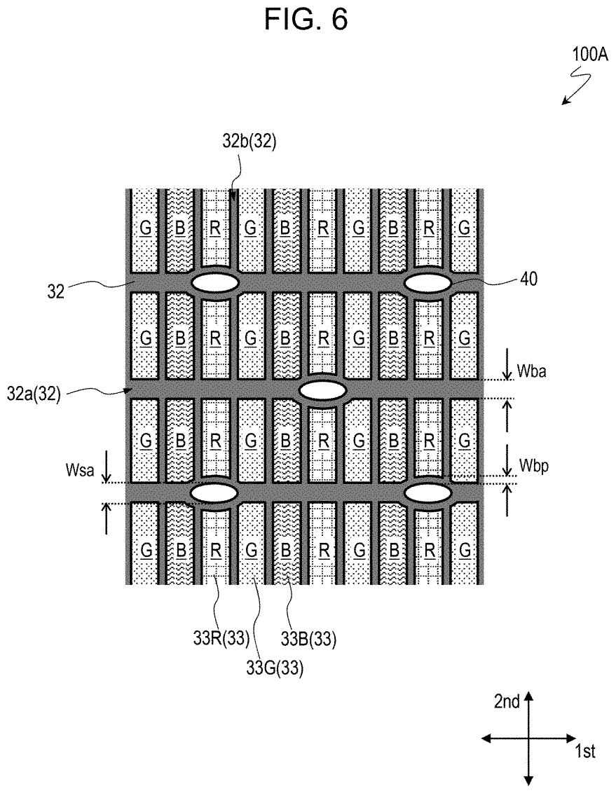

As illustrated in FIG. 3, the liquid crystal display device 100A includes a plurality of pixels arranged in a matrix shape having a plurality of rows and a plurality of columns. As illustrated in FIG. 6 described below, the plurality of pixels constitute a plurality of color display pixels. One color display pixel is constituted by red green (G), and blue (B) pixels arranged in the first direction (row direction), and an R pixel row, a G pixel row, and a B pixel row are arranged in a stripe shape (that is, different colors are displayed in each pixel row). The arrangement of the plurality of pixels is so-called as a “stripe arrangement” or a “vertical stripe arrangement”. In the liquid crystal display device 100A, a pixel pitch (Px in FIG. 3) in the first direction is smaller than a pixel pitch (Py in FIG. 3) in the second direction.

The TFT 15 includes a gate electrode 12g, a source electrode 16s, and a drain electrode 18d. The TFT 15 further includes a semiconductor layer 14 as an active layer. The gate electrode 12a is electrically connected to the gate bus line GL and supplies a gate signal (scanning signal) from the gate bus line GL. In the illustrated example, a part of the gate bus line GL (a region overlapping the semiconductor layer 14) functions as the gate electrode 12g. The source electrode 16s is electrically connected to the source bus line SL and supplies a source signal (display signal) from the source bus line SL, In the illustrated example, the source electrode 16s extends to be branched from the source bus line SL. The drain electrode 18d is electrically connected to the pixel electrode 18a.

A region contacting the source electrode 16s in the semiconductor layer 14 is so-called as a “source region”, and a region contacting the drain electrode 18d is so-called as a “drain region”. In addition, in the semiconductor layer 14, a region overlapping the gate electrode 12g and located between the source region and the drain region is so-called as a “channel region”.

The semiconductor layer 14 is, for example, an oxide semiconductor layer. The semiconductor layer 14 is not limited to this, but for example, may be an amorphous silicon layer or a crystalline silicon layer. The crystalline silicon layer may be, for example, a polysilicon layer.

The TFT 15 is supported by the transparent insulating substrate (for example, a glass substrate) 11.

The first conductive layer 12 is supported by the substrate 11, and includes the gate electrode 12g and the plurality of pate bus lines GL. Here, the first conductive layer 12 is formed on the surface of the substrate 11 on the liquid crystal layer 50 side.

The second conductive layer 16 is supported by the substrate 11, and includes the source electrode 16s and the plurality of source bus lines SL. The gate insulating layer 13 is formed between the first conductive layer 12 and the second conductive layer 16. Here, the gate insulating layer 13 is formed to cover the first conductive layer 12, and the second conductive layer 16 is formed on the ate insulating layer 13. The semiconductor layer 14 of the TFT 15 is formed on the gate insulating layer 13. The source electrode 16s is formed to be in contact with an upper surface of a source region of the semiconductor layer 14.

The interlayer insulating layer 17 is formed on the semiconductor layer 14 and the second conductive layer 16. The interlayer insulating layer 17 is formed to cover the semiconductor layer 14 and the second conductive layer 16. The interlayer insulating layer 17 has an opening portion 17h reaching to a drain region of the semiconductor layer 14. The interlayer insulating layer 17 is formed of an inorganic material. The interlayer insulating layer 17 does not Include an organic insulating layer.

In general, the interlayer insulating layer covering the TFT, the gate bus line, and the source bus line in the TFT substrate may include a relatively thick (for example, having a thickness of about 1 μm to 3 μm) organic insulating layer. An organic insulating material has a lower dielectric constant than that of the inorganic insulating material, and tends to be thickly deposited. When the interlayer insulating layer is formed, the surface can be flattened before forming a transparent electrode.

In the present embodiment, since the interlayer insulating layer 17 does not include the organic insulating layer, a height of the surface of the TFT substrate 10 on the liquid crystal layer 50 side, in a portion having a laminated structure including the first conductive layer 12 and/or the second conductive layer 16 in the TFT substrate 10, is higher than a height of the surface of the TFT substrate 10 on the liquid crystal layer 50 side in the other portion thereof. For example, a height of the surface of the TFT substrate 10 on the liquid crystal layer 50 side, in the portion overlapping the plurality of the gate bus lines and the portion overlapping the plurality of source bus lines, is higher than the surrounding thereof. Therefore, a plurality of first projections overlapping the plurality of gate bus lines and a plurality of second projections overlapping the plurality of source bus lines are formed on the surface of the TFT substrate 10 on the liquid crystal layer 50 side. Here, the TFT substrate 10 includes the first conductive layer 12 and the second conductive layer 16 in a region overlapping the first projection and a region overlapping the second projection.

The first transparent conductive layer 18 is formed on the interlayer insulating layer 17. The first transparent conductive layer 18 is formed of a transparent conductive material, and includes a first transparent electrode 18a provided in each pixel. Here, the first transparent electrode 18a functions as a pixel electrode. In the present embodiment, the first transparent electrode 18a is formed of a transparent electrode film which is the same as the pixel electrode 18a, and a portion extending from the pixel electrode 18a functions as the drain electrode 18d. That is, the first transparent conductive layer 18 includes the pixel electrode 18a and the drain electrode 18d, and the drain electrode 18d is transparent. In the present specification, the drain electrode 18d is so-called as a “transparent drain electrode”, and a contact structure including the transparent drain electrode 18d is so-called as a “transparent contact structure”. The drain electrode 18d is in contact with an upper surface of the semiconductor layer 14 in the drain region, in the opening portion 17h formed in the interlayer insulating layer 17.

The inorganic insulating layer 19 is formed on the first transparent conductive layer 18. The inorganic insulating layer 19 is formed to cover the pixel electrode 18a and the drain electrode 18d.

The second transparent conductive layer 20 is formed on the inorganic insulating layer 19. The second transparent conductive layer 20 is formed of a transparent conductive material. The second transparent conductive layer 20 functions as a common electrode (referred to as a “counter electrode”). The common electrode 20 includes at least one (for example, one illustrated in FIG. 3) slit 20s in the region corresponding to each pixel. An auxiliary capacitance is constituted by the pixel electrode 18a, the common electrode 20, and the inorganic insulating layer 19 located between the pixel electrode 18a and the common electrode 20.

The counter substrate 30 includes a color filter layer (not illustrated) and a light shielding layer (black matrix; not illustrated). The color filter layer and the light shielding layer are supported by the transparent insulating substrate (for example, a glass substrate) 31. The counter substrate 30 further includes an overcoat layer (not illustrated) covering the light shielding layer and the color filter layer. The overcoat layer is formed, such that the surface can be flattened before forming the columnar spacer.

The counter substrate 30 further includes the plurality of columnar spacers 40. The plurality of columnar spacers 40 are provided on the overcoat layer. The plurality of columnar spacers 40 are formed of, for example, a photosensitive resin material.

The counter substrate 30 further includes an alignment film 39 on a surface on the liquid crystal layer 50 side. The alignment film 39 is formed to cover the overcoat layer and the plurality of columnar spacers 40.

The liquid crystal layer 50 is a horizontal alignment type. Horizontal alignment films 29 and 39 are provided on the surfaces of the TFT substrate 10 and the counter substrate 30 on the liquid crystal layer 50 side, respectively. The horizontal alignment film has an alignment regulating force for aligning the liquid crystal molecules in the liquid crystal layer 50 substantially parallel to the surface thereof. As the alignment film, an alignment film subjected to an alignment treatment by optical alignment processing (an optical alignment film) may be used, or an alignment film subjected to an alignment treatment by rubbing alignment processing may be used.

The specific structure of the TFT 15 is not limited to that illustrated herein. The TFT 15 may be a bottom-gate type or a top gate type as illustrated. The drain electrode 18d having the TFT 15 may not be a transparent drain electrode (for example, may be included in the second conductive layer 16).

When the TFT of the liquid crystal display device includes the transparent drain electrode (that is, the contact structure is adopted), the opening ratio can be improved, and also, degradation in the display quality due to partially peeling-off of the alignment film by the columnar spacer tends to occur. Accordingly, when the transparent contact structure is adopted as in the present embodiment, an effect capable of suppressing degradation in the display quality is remarkable by having the columnar spacer 40.

The liquid crystal display device in the FFS mode according to the embodiment of the present invention is not limited to the illustrated configuration, but can be widely applied to the known liquid crystal display device in the FFS mode. For example, as arrangement relationship between the pixel electrode and the common electrode may be reversed. That is, the pixel electrode may be included in the second transparent conductive layer 20, and the common electrode may be included in the first transparent conductive layer 18. In addition, the liquid crystal display device according to the embodiment of the present invention is not limited to the liquid crystal display device may be a liquid crystal display device in a horizontal electrical field mode, but may be a liquid crystal display device in a vertical electrical field mode such as a VA mode or a TN mode. In the liquid crystal display device in the VA mode or the TN mode, the pixel electrode is formed in the second transparent conductive layer 20, and an auxiliary capacitance electrode is formed in the first transparent conductive layer 18, and the counter electrode facing the pixel electrode may be provided in the counter substrate 30.

The plurality of columnar spacer 40 may further include a second columnar spacer lower than the first columnar spacer 40a. A second columnar spacer 40b will be described with reference to FIG. 5. FIG. 5 is another cross-sectional view schematically illustrating the liquid crystal display device 100A. FIG. 5 illustrates a cross section perpendicular to the second direction.

The first columnar spacer 40a is in contact with both of the TFT substrate 10 and the counter substrate 30, and the second columnar spacer 40b is only in contact with the counter substrate 30. That is, the second columnar spacer 40b is not in contact with the TFT substrate 10. The first columnar spacer 40a is so-called as a “main spacer”, and the second columnar spacer 40b is so-called as a “sub-spacer”. When a liquid crystal panel is pressed, the second columnar spacer 40b may come into contact with both of the substrates.

The second columnar spacer 40b is constituted so as to overlap at least two of the plurality of source bus lines SL when viewed from a normal direction of the TFT substrate 10. For example, even if a force from the outside is applied to the liquid crystal display device 100A and the second columnar spacer 40b comes into contact with the TFT substrate 10, the second columnar spacer 40b having such a structure hardly comes into contact with the portion other than the projection R2 in the surface of the TFT substrate 10 on the liquid crystal layer 50 side. Accordingly, the alignment film 29 partially formed in a portion other than the projection R2, among the alignment films 29 of the TFT substrate 10, is prevented from scraping by the second columnar spacer 40b.

However, the second columnar spacer (sub-spacer) of the liquid crystal display device 100A is not limited to that having the above configuration. When viewed from the normal direction of the TFT substrate 10, only one of the plurality of source bus lines SL may be constituted so as to overlap each other. This is because it is assumed that the sub-spacer is not in contact with the TFT substrate 10 unless a great force from the outside is applied, and thus the alignment film is partially peeled off by the sub-spacer and the display quality due to the partially peeling-off is less degraded.

The second columnar spacer 40b is lower, for example, about 0.5 μm than the first columnar spacer 40a. A ratio of the number of first columnar spacer 40a per unit area and the number of second columnar spacer 40b per unit area can be appropriately adjusted, for example, 1:10. The number of second columnar spacer 40b increases, such that it is possible to improve pressing resistance of the liquid crystal display device.

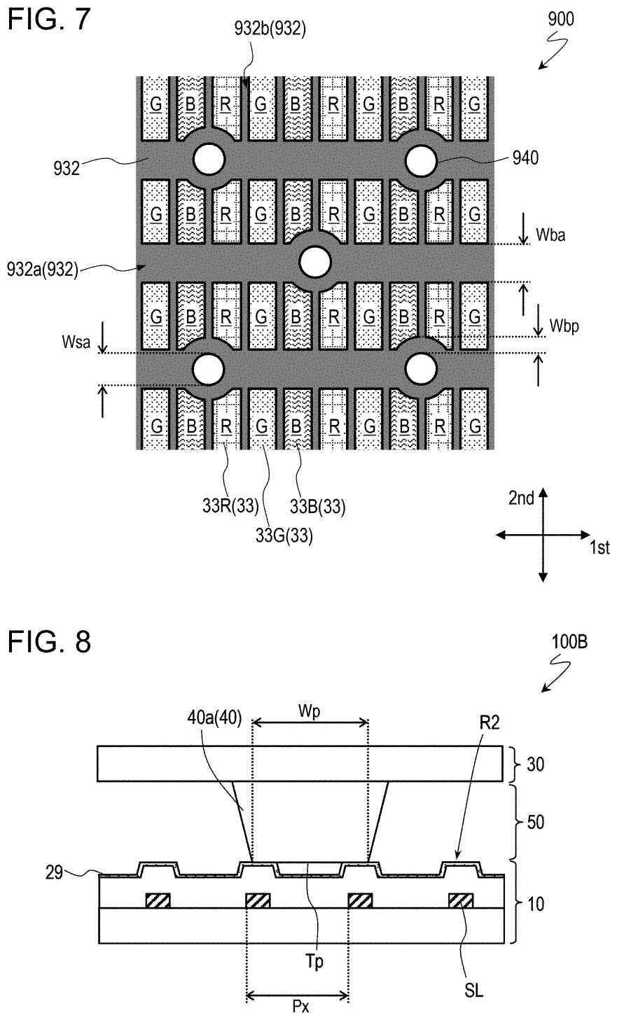

With reference to FIGS. 6 and 7, it is described that the liquid crystal display device 100A can obtain a high opening ratio as compared with the liquid crystal display device 900 of the comparative example. FIG. 6 is a plan view schematically illustrating disposition of a light shielding layer (black matrix) 32, a color filter layer 33, and the columnar spacer 40 in the liquid crystal display device 100A, and FIG. 7 is a plan view schematically illustrating disposition of a light shielding layer 932, the color filter layer 33, and a columnar spacer 940 of the liquid crystal display device 900 of the comparative example. In FIG. 7, constituent elements having substantially the same as that of the liquid crystal display device 100A are denoted by the same reference numerals, and the description thereof is omitted.

As illustrated in FIG. 6, the light shielding layer 32 of the liquid crystal display device 100A includes a plurality of first light shielding portions 32a extending in the first direction and a plurality of second light shielding portions 32b extending in the second direction. When viewed from the normal direction of the TFT substrate 10, the first light shielding portions 32a overlap the gate bus lines GL, respectively, and the second light shielding portions 32b overlap the source bus lines SL, respectively. That is, the first light shielding portions 32a overlap the first projections, respectively, and the second light shielding portions 32b overlap the second projections, respectively, when viewed from the normal direction of the TFT substrate 10. Each columnar spacer 40 is formed to overlap at least two second light shielding portions 32b (here, two mutually adjacent second light shielding portions 32b). The columnar spacer 40 in FIG. 6 may include the first columnar spacer 40a and the second columnar spacer 40b. The color filter layer 33 includes a red color filter 33R, a green color filter 33G, and a blue color filter 33B. Note that, a relationship between disposition of the columnar spacer 40 and the color filter layer 33 or an arrangement density of the columnar spacer 40 is not limited to that illustrated herein.

As illustrated in FIG. 7, the light shielding layer 932 of the liquid crystal display device 900 of the comparative example includes a plurality of first light shielding portions 932a extending in the first direction and a plurality of second light shielding portions 932b extending in the second direction. As described above, in the liquid crystal display device 900 of the comparative example, the alignment film 29 formed in a portion other than the projection. (including the first projection and the second projection), among the alignment films 29 of the TFT substrate 10, may be scraped by the columnar spacer 940. In order to suppress degradation in the display quality due to this, a width of the first light shielding portion 932a of the pixel having the columnar spacer 940 is set to be relatively larger than a length Wsa of the columnar spacer 940 in the second direction. In FIG. 7, a difference in length (that is, a difference in length between the width of the first light shielding portion 932a of the pixel having the columnar spacer 940 and the length Wsa of the columnar spacer 940 in the second direction) is referred to as Wbp. Here, the length Wsa of the columnar spacer 940 in the second direction is, for example, a length of a bottom surface (bottom portion) of the columnar spacer 940 in the second direction. The same is applied to the length Wsa of the columnar spacer 40 of the liquid crystal display device 100A in the second direction.

In addition, it is preferable that a difference in an opening ratio between a R pixel, a G pixel, and a B pixel is small, and thus when the length of Wbp becomes large, a width Wba of the first light shielding portion 932a of the pixel not having the columnar spacer 940 may also become large.

On the other hand, in the liquid crystal display device 100A, the alignment film 29 formed in a portion other than the projection (including the first projection and the second projection), among the alignment films 29 of the TFT substrate 10, is suppressed to be scraped by the columnar spacer 40. Accordingly, as illustrated in FIG. 6, a difference in length Wbp between the width of the first light shielding portion 32a of the pixel having the columnar spacer 40 and the length Wsa of the columnar spacer 40 in the second direction can be smaller as compared with the liquid crystal display device 900 of the comparative example. For example, from the viewpoint of securing the display quality, it is preferable that the length Wbp of the liquid crystal display device 900 of the comparative example is about 6 μm to 7 μm. However, the length Wbp of the liquid crystal display device 100A can be about 2 μm to 3 μm while keeping the display quality.

In addition, the width Nba of the first light shielding portion 32a of the pixel not having the columnar spacer 40 of the liquid crystal display device 100A is smaller than the width Wba of the first light shielding portion 932a of the pixel not having the columnar spacer 940 of the liquid crystal display device 900 in the comparative example.

Therefore, since an area of the light shielding layer 32 can be smaller than that of the liquid crystal display device 900 of the comparative example, the liquid crystal display device 100A can improve the opening ratio as compared with the liquid crystal display device 900 of the comparative example.

The shape of the columnar spacer 40 is not limited to the illustrated example, but may have various shapes (for example, a substantially square shape, a substantially hexagonal shape, and the like). In FIG. 3, it is illustrated that the shape of the columnar spacer 40 is substantially circular when viewed from the normal direction of the substrate 11. However, as illustrated in FIG. 6, the shape of the columnar spacer 40 may be substantially elliptic when viewed from the normal direction of the substrate 11. The length of the columnar spacer 40 in the second direction is small, such that it is possible to further improve the opening ratio of the liquid crystal display device 100A.

### [Manufacturing Method]

The liquid crystal display device 100A in the present embodiment can be manufactured, for example, as follows.

First, a manufacturing method of the counter substrate 30 will be described.

First, a light shielding film is deposited on a transparent substrate (for example, a glass substrate) 31 and the light shielding film is patterned into a desired shape by a photolithography process, thereby forming the light shielding layer 32. The light shielding layer 32 is, for example, a Ti layer with a thickness of 200 nm. A material of the light shielding layer 32 is not limited to a metallic material as illustrated, but for example, may be a black photosensitive resin material.

Next, the color filter layer 33 is formed by sequentially forming the red color filter 33R, the green color filter 33G, and the blue color filter 33B in a region corresponding to the red (R) pixel, the green (G) pixel, and the blue (B) pixel. As a material of the red color filter 33R, the green color filter 33G, and the blue color filter 33B, the colored photosensitive resin material can be used, for example.

Next, the overcoat layer covering the color filter layer 33 is formed. The overcoat layer is formed using an organic material such as a thermosetting resin or a photosensitive resin.

Subsequently, the plurality of columnar spacers 40 are formed on the overcoat layer. The plurality of columnar spacers 40 are formed of, for example, a photosensitive resin material.

Finally, the alignment film 39 is formed to cover the overcoat layer and the columnar spacer 40 and subjected to an alignment treatment (for example, optical alignment processing), thereby obtaining the counter substrate 30.

Next, a manufacturing method of the TFT substrate 10 will be described.

First, a conductive film is deposited on a transparent substrate (for example, a glass substrate) 11 and the conductive film is patterned into a desired shape by a photolithography process, thereby forming the first conductive layer 12 including the gate electrode 12g and the gate bus line GL. The first conductive layer 12 has, for example, a laminated structure in which a TaN layer with a thickness of 30 nm and a N layer with a thickness of 300 nm are laminated in this order.

Next, the pate insulating layer 13 is formed to cover the first conductive layer 12. The gate insulating layer 13 has, for example, a laminated structure in which a SiNx layer with a thickness of 325 nm and a SiO₂ layer with a thickness of 50 nm are laminated in this order.

Subsequently, an oxide semiconductor film is deposited on the gate insulating layer 13 and the oxide semiconductor film is patterned into a desired shape by a photolithography process, thereby forming an oxide semiconductor layer 14. The oxide semiconductor layer 14 is, for example, an In-Ga-Zn-O-based semiconductor layer with a thickness of 50 nm.

Then, the conductive layer is deposited and the conductive layer is patterned into a desired shape by a photolithography process, thereby forming the second conductive layer 16 including the source electrode 16s and the source bus line SL. The second conductive layer 16 has, for example, a laminated structure in which a Ti layer with a thickness of 30 nm, an Al layer with a thickness of 200 nm, and Ti layer with a thickness of 100 nm are laminated in this order.

Next, the interlayer insulating layer 17 is formed to cover the oxide semiconductor layer 14 and the second conductive layer 16. The interlayer insulating layer 17 is, for example, a SiO₂ layer with a thickness of 300 nm. The interlayer insulating layer 17 has an opening portion. 17h reaching to a drain region of the semiconductor layer 14.

Then, the transparent conductive film is deposited on the interlayer insulating layer 17 and the transparent conductive film is patterned into a desired shape by a photolithography process, thereby forming the first transparent conductive layer 18 including the pixel electrode 18a and the drain electrode 18d. The first transparent conductive layer 18 is, for example, an IZO layer with a thickness of 100 nm.

Next, the inorganic insulating layer 19 is formed to cover the first transparent conductive layer 18. The inorganic insulating layer 19 is, for example, a SiN layer with a thickness of 100 nm.

Subsequently, the transparent conductive film is deposited on the inorganic insulating layer 19 and the transparent conductive film is patterned into a desired shape by a photolithography process, thereby forming the second transparent conductive layer 20 including the common electrode 20 having a slit 20s. The second transparent conductive layer 20 is, for example, an IZO layer with a thickness of 100 nm.

Then, the alignment film 29 is formed on the entire surface to cover the second transparent conductive layer 20 and subjected to an alignment treatment (for example, optical alignment processing), thereby obtaining the TFT substrate 10.

The TFT substrate 10 and the counter substrate 30 manufactured as described above are laminated to each other and a liquid crystal material is injected to a gap between the TFT substrate 10 and the counter substrate 30 to form the liquid crystal layer 50. Thereafter, the liquid crystal display device 100A is completed by cutting the obtained structure into individual panels.

### Embodiment 2

A liquid crystal display device 100B of the present embodiment will be described with reference to FIG. 8. FIG. 8 is a cross-sectional view schematically illustrating the liquid crystal display device 100B. Hereinafter, the difference between the liquid crystal display device 100B and the liquid crystal display device 100A in Embodiment 1 will be mainly described.

In the liquid crystal display device 100B,as illustrated in FIG. 8, the width Wp of the top surface Tp of the first columnar spacer 40a may be larger than a pixel pitch Px in the plurality of pixels, in a direction perpendicular to a direction to which two projections R2 supported by the first columnar spacer 40a extend (that the second direction). In the illustrated example, Px is a pixel pitch in the first direction perpendicular to the second direction. The first columnar spacer 40a having such a structure is more difficult to be in contact with a portion other than the projection R2 in the surface of the TFT substrate 10 on the liquid crystal layer 50 side. For example, even though the positional relationship between the TFT substrate 10 and the counter substrate 30 deviates in a direction perpendicular to the second direction from a state illustrated in FIG. 8 (a lateral direction of FIG. 1), the first columnar spacer 40a is difficult to enter into the recess which is formed between the two mutually adjacent projections R2 because the two mutually adjacent projections R2 is supported to each other at all times. In the liquid crystal display device 100B, the alignment film 29 formed in a portion other than the projection (including the first projection and the second projection), among the alignment films 29 of the TFT substrate 10, is more efficiently suppressed to be scraped.

### Embodiment 3

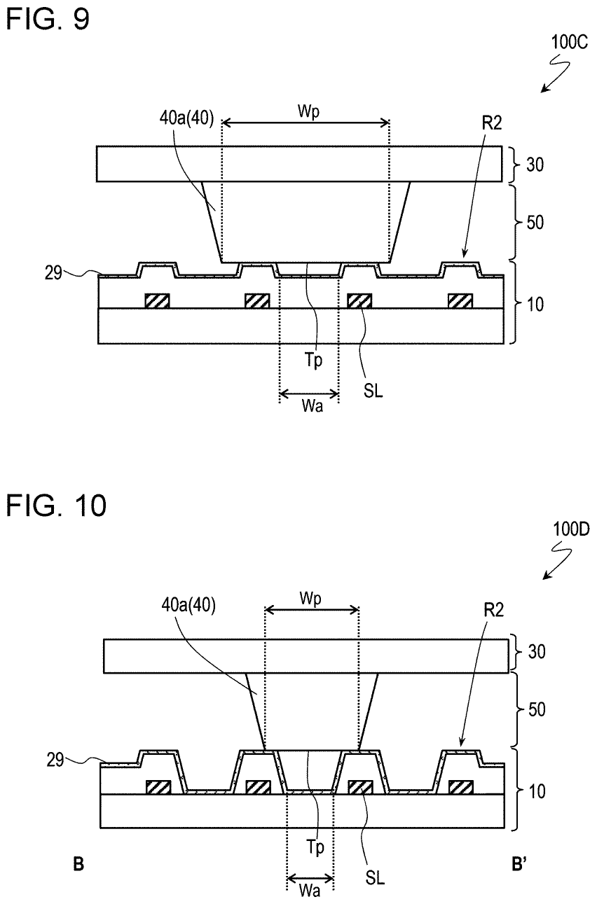

A liquid crystal display device 1000 of the present embodiment will be described with reference to FIG. 9. FIG. 9 is a cross-sectional view schematically illustrating the liquid crystal display device 100C. Hereinafter, the difference between the liquid crystal display device 1000 and the liquid crystal display device 1002 in Embodiment 1 will be mainly described.

In the liquid crystal display device 100C, as illustrated in FIG. 9, the width Wp of the top surface Tp of the first columnar spacer 40a covers at least two projections R2 supported by the first columnar spacer 40a, in a direction perpendicular to a direction to which two projections R2 supported by the first columnar spacer 40a extend (that is, the second direction). Here, the width Wp of the top surface Tp of the first columnar spacer 40a covers two mutually adjacent projections R2 in a direction perpendicular to the second direction. The first columnar spacer 40a having such a structure is more difficult to he in contact with a portion other than the projection R2 in the surface of the TFT substrate 10 on the liquid crystal layer 50 side. In the liquid crystal display device 100C, the alignment film 29 formed in a portion other than the projection (including the first projection and the second projection), among the alignment films 29 of the TFT substrate 10, is more efficiently suppressed to be scraped.

### Embodiment 4

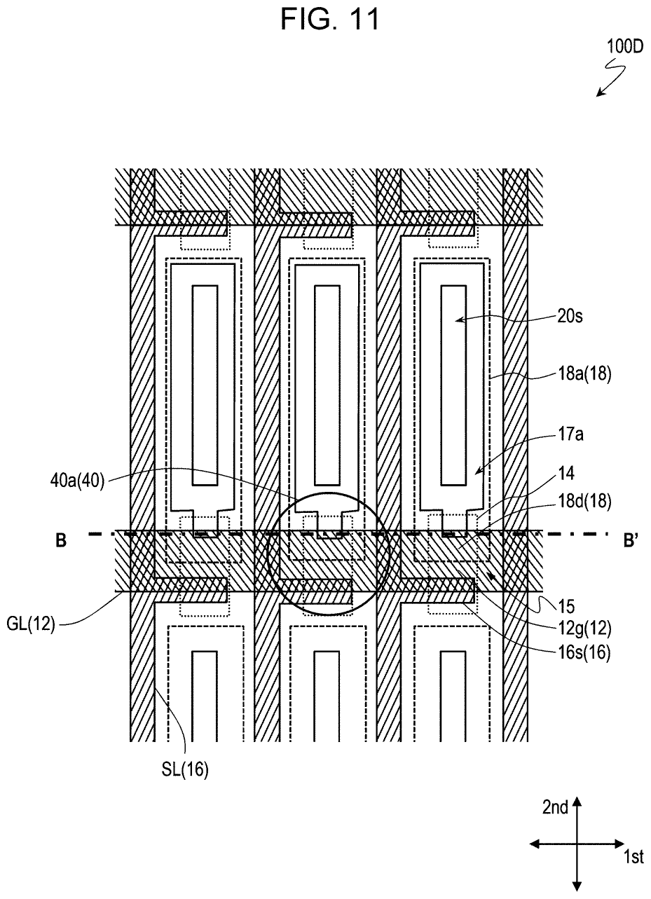

A liquid crystal display device 100D of the present embodiment will be described with reference to FIGS. 10 and 11. FIGS. 10 and 11 are a cross-sectional view and a plan view schematically illustrating the liquid crystal display device 100D. FIG. 10 illustrates a cross section taken along line B-B′ in FIG. 11. Hereinafter, the difference between the liquid crystal display device 100D and the liquid crystal display device 100A in Embodiment 1 will be mainly described.

As illustrated in FIGS. 10 and 11, the TFT substrate 10 of the liquid crystal display device 100D includes a region disposed between the mutually adjacent projections R2 in at least two projections R2 supported by the first columnar spacer 40a and not having the interlayer insulating layer 17. The interlayer insulating layer 17 has an opening portion 17a between the mutually adjacent projections R2.

The liquid crystal display device 100D includes the region disposed between the mutually adjacent projections R2 and not hazing the interlayer insulating layer 17, and thus, as compared with the liquid crystal display device 100A, a difference between a height of the projection R2 (a height of the surface of the projection R2 and a surface of the TFT substrate 10 on the liquid crystal layer 50 side) and a height of the recess formed between the two adjacent projections R2 (a height of the surface of the recess and the surface of the TFT substrate 10 on the liquid crystal layer 50 side). Therefore, it is efficiently suppressed that the alignment film 29 formed in the recess formed between the two adjacent projections R2 is scraped.

In order to suppress the alignment film 29 formed in a region contributed to the display is scraped, it is preferable that the opening portion 17a is formed in the region contributed to the display. In this case, the opening portion 17a overlaps the pixel electrode 18a when viewed from the normal direction of the TFT substrate 10. As illustrated, the entire opening portion 17a may not overlap the pixel electrode 18a when viewed from the normal direction of the TFT substrate 10. Here, the opening portion 17a reaches the drain region of the semiconductor layer 14, the drain electrode 18d is in contact with an upper surface of the semiconductor layer 14 in the drain region in the opening portion 17a formed in the interlayer insulating layer 17. Note that, the size or shape of the opening portions 17a is not particularly limited.

### Embodiment 5

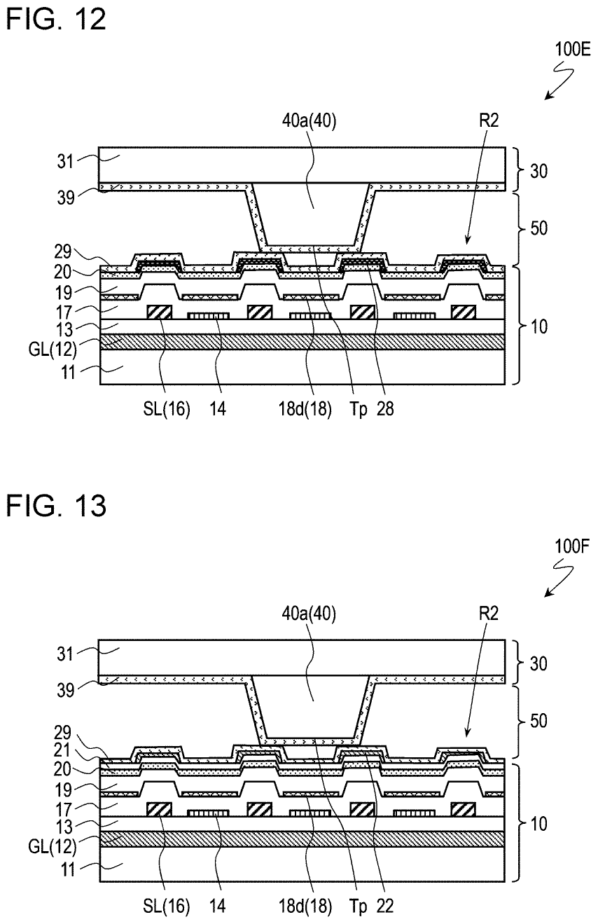

A liquid crystal display device 100E of the present embodiment will be described with reference to FIG. 12. FIG. 12 is a cross-sectional view schematically illustrating the liquid crystal display device 100E. Hereinafter, the difference between the liquid crystal display device 100E and the liquid crystal display device 100A in Embodiment 1 will be mainly described.

As illustrated in FIG. 12, the TFT substrate 10 of the liquid crystal display device 100E further includes a light shielding layer 28 formed on the interlayer insulating layer 17 in the region overlapping at least two projections R2 supported by the first columnar spacer 40a. The light shielding layer 28 overlaps the source bus line SL when viewed from the normal direction of the TFT substrate 10. Here, the light shielding layer 28 is formed on the second transparent conductive layer 20 so as to be in contact with the second transparent conductive layer 20. The light shielding layer 28 may be formed below the second transparent conductive layer 20 so as to be in contact with the second transparent conductive layer 20. For example, the light shielding layer 28 may be formed of, for example, a metallic material or a black photosensitive resin material.

Since the TFT substrate 10 of the liquid crystal display device 100E further includes the light shielding layer 28, the height of the surface of the projection R2 and the surface of the TFT substrate 10 on the liquid crystal layer 50 side is higher as compared with the liquid crystal display device 100A. That as compared with the liquid crystal display device 100A, a difference between a height of the projection R2 (a height of the surface of the projection R2 and a surface of the TFT substrate 10 on the liquid crystal layer 50 side) and a height of the recess formed between the two adjacent projections R2 (a height of the surface of the recess and the surface of the TFT substrate 10 on the liquid crystal layer 50 side). Accordingly, it is efficiently suppressed that the alignment film 29 formed in the recess formed between the two adjacent projections R2 is scraped.

When an alignment deviation occurs between the TFT substrate 10 and the counter substrate 30 in the liquid crystal display device 100A and a part of the source bus line SL is not covered with the light shielding layer 32 of the counter substrate 30, the display quality may be degraded due to surface reflection for the part of the source bus line SL. By having the light shielding layer 28 overlapping the source bus lane SL, the liquid crystal display device 100E can suppress degradation in the display quality due to surface reflection for the source bus line SL even when the alignment deviation occurs between the TFT substrate 10 and the counter substrate 30.

### Embodiment 6

A liquid crystal display device 100F of the present embodiment will be described with reference to FIG. 13. FIG. 13 is a cross-sectional view schematically illustrating the liquid crystal display device 100F. Hereinafter, the difference between the liquid crystal display device 100F and the liquid crystal display device 100A in Embodiment 1 will be mainly described.

As illustrated in FIG. 13, the TFT substrate 10 of the liquid crystal display device 100F further includes a third conductive layer 22 formed on the interlayer insulating layer 17 in the region overlapping at least two projections R2 supported by the first columnar spacer 40a. The third conductive layer 22 is formed on the second transparent conductive layer 20 through the insulating layer 21. The third conductive layer 22 overlaps the source bus line SL when viewed from the normal direction of the TFT substrate 10.

The third conductive layer 22 is formed independently separately from the first transparent conductive layer 18 and the second transparent conductive layer 20 as a conductive layer, and includes neither the pixel electrode, the common electrode, and the auxiliary capacitance electrode. For example, in a liquid crystal display panel TFT substrate having a touch screen function, the third conductive layer 22 may be, for example, a conductive layer for forming a plurality of signal lines connected to at least one of a plurality of common electrodes and transmitting and receiving the touch driving signal and a touch detecting signal from a touch screen control circuit. Alternately, the third conductive layer 22 may be a conductive layer for forming an auxiliary line for reducing an electric resistance of the common electrode 20. The third conductive layer 22 may function as a light shielding layer in Embodiment 5.

Since the TFT substrate 10 of the liquid crystal display device 100F further includes the third conductive layer 22, the height of the surface of the projection R2 and the surface of the TFT substrate 10 on the liquid crystal layer 50 side is higher as compared with the liquid crystal display device 100A. That is, as compared with the liquid crystal display device 100A, a difference between a height of the projection R2 (a height of the surface of the projection R2 and a surface of the TFT substrate 10 on the liquid crystal layer 50 side) and a height of the recess formed between the two adjacent projections R2 (a height in the surface of the recess and the surface of the TFT substrate 10 on the liquid crystal layer 50 side). Accordingly, it is efficiently suppressed that the alignment film 29 formed on the recess formed between the two adjacent projections R2 is scraped.

### Embodiment 7

In the embodiments above, the example has been described in which the first columnar spacer supports at least two projections among the plurality of projections overlapping the plurality of source bus lines on the top surface, but the embodiments of the present invention are not limited to this. In the present embodiment, the example will be described in which the first columnar spacer supports at least two projections among the plurality of projections overlapping the plurality of gate bus lines on the top surface.

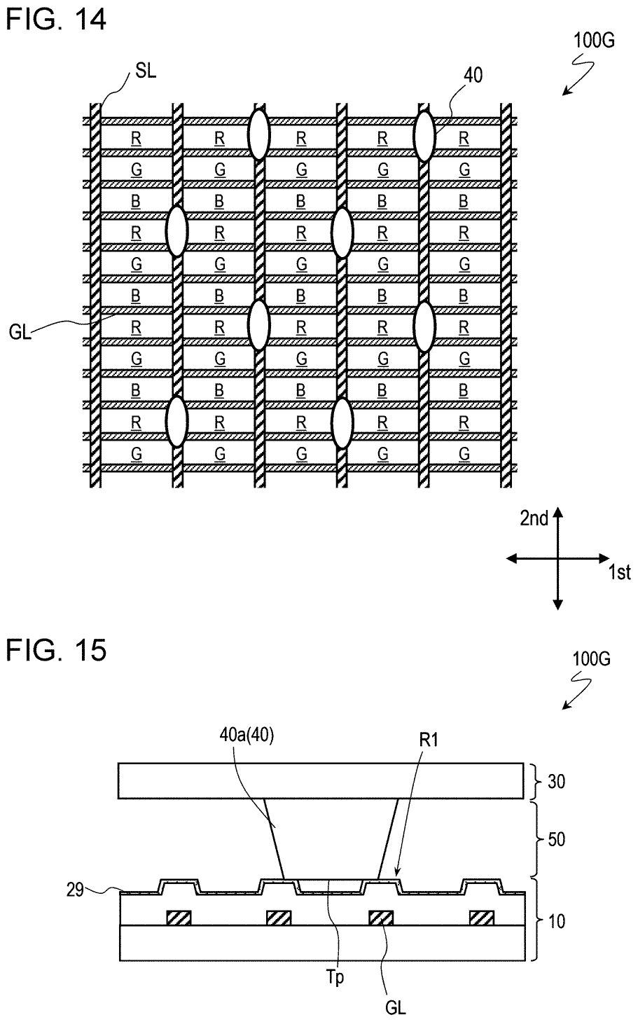

A liquid crystal display device 100G of the present embodiment will be described with reference to FIGS. 14 and 15. FIGS. 14 and 15 are a plan view and a cross-sectional view schematically illustrating the liquid crystal display device 100G. Hereinafter, the difference between the liquid crystal display device 100G and the liquid crystal display device 100A in Embodiment 1 will be mainly described. FIG. 15 illustrates a cross section perpendicular to the first direction.

As illustrated in FIG. 15, the first columnar spacer 40a of the liquid crystal display device 100E supports at least two projections R1 among the plurality of first projections R1 overlapping the plurality of gate bus lines GL on the top surface Tp.

Also, the liquid crystal display device 100E having such a configuration obtains the same effect as that of the liquid crystal display device 100A. Since the first columnar spacer 40a is hardly in a contact with the portion other than the projection R1 in the surface of the TFT substrate 10 on the liquid crystal layer 50 side, the alignment film 29 formed in a portion other than the projection (including the first projection and the second projection) among the alignment films 29 of the TFT substrate 10 of the liquid crystal display device 100E is suppressed to be scraped. Accordingly, degradation in the display quality is suppressed. In order to suppress the degradation in the display quality, it is not necessary that an area of the light shielding layer becomes larger than that of the related art. The liquid crystal display device 1000 described above can suppress degradation in the display quality due to partially peeling-off of the alignment film by the columnar spacer, while suppressing reduction of the opening ratio.

As illustrated in FIG. 14, one color display pixel of the liquid crystal display device 100Gis constituted by red. (R), green. (G), and blue (B) pixels arranged in the second direction (column direction), and an R pixel column, a G pixel column, and a B pixel column are arranged in a stripe shape (that is, different colors are displayed in each pixel column). The arrangement of the plurality of pixels is so-called as a “lateral stripe arrangement”. In the liquid crystal display device 1006, a pixel pitch in the second direction is smaller than a pixel pitch in the first direction.

The plurality of columnar spacers 40 may further include a second columnar spacer (sub-spacer). The columnar spacer 40 in FIG. 14 may include the first columnar spacer 40a and the second columnar spacer 40b. The second columnar spacer 40b in FIG. 14 overlaps at least two of the plurality of gate bus lines GL without being in contact with the TFT substrate 10, when viewed from a normal direction of the TFT substrate 10.

### [For Oxide Semiconductor]

The semiconductor layer 14 may be an oxide semiconductor layer. The oxide semiconductor of the oxide semiconductor layer 14 may be an amorphous oxide semiconductor or a crystalline oxide semiconductor having a crystalline portion. Examples of the crystalline oxide semiconductor include a polycrystalline oxide semiconductor, a microcrystalline oxide semiconductor, and a crystalline oxide semiconductor with a c-axis aligned roughly perpendicularly to a layer surface.

The oxide semiconductor layer 14 may have a laminated structure of two or more layers. When the oxide semiconductor layer 14 has a laminated structure, the oxide semiconductor layer 14 may include an amorphous oxide semiconductor layer and a crystalline oxide semiconductor layer, a plurality of crystalline oxide semiconductor layers with different crystalline structure, or a plurality of amorphous oxide semiconductor layers. When the oxide semiconductor layer 14 has two-layer structure including an upper layer and a lower layer, it is preferable that as energy gap of the oxide semiconductor of the upper layer is larger than an energy gap of the oxide semiconductor of the lower layer. However, when a difference in the energy gap of the layers is relatively small, the energy gap of the oxide semiconductor of the lower layer is larger than the energy gap of the oxide semiconductor of the upper layer.

A configuration of the oxide semiconductor layer having a material, a structure, a film forming method, and a laminated structure of the amorphous oxide semiconductor and each crystalline oxide semiconductor above is described in, for example, Japanese Unexamined Patent Application Publication. No. 2014-007399. All of the contents described in Japanese Unexamined Patent Application Publication No. 2014-007399 are adopted in the present specification for reference.

The oxide semiconductor layer 14 may include, for example, a metallic element at least one of In, Ga, and Zn. In the present embodiment, the oxide semiconductor layer 14 includes, for example, an In-Ga-Zn-O-based semiconductor (for example, indium, gallium, zinc oxide). Here, the In-Ga-Zn-O-based semiconductor is a ternary oxide of indium (In), gallium (Ga), and zinc (Zn) and a proportion (composition ratio) of In, Ga, and Zn is not particularly limited, but the proportion of In, Ga, and Zn is, for example, 2:2:1, 1:1:1, 1:1:2, or the like. The oxide semiconductor layer 14 may be formed of an oxide semiconductor film including an In-Ga-Zn-O-based semiconductor.

The In-Ga-Zn-O-based semiconductor may be amorphous, or crystalline. As a crystalline In-Ga-Zn-O-based semiconductor is preferably a crystalline In-Ga-Zn-O-based semiconductor with the c-axis aligned roughly perpendicularly to a Paver surface.

A crystalline structure of the crystalline In-Ga-Zn-O-based semiconductor is described in, for example, Japanese Unexamined Patent Application Publication No. 2014-007399 described above, Japanese Unexamined Patent Application Publication. No. 2012-134475, and Japanese Unexamined Patent Application Publication No, 2014-209727. All of the contents described in Japanese Unexamined Patent Application Publication Nos. 2012-134475 and 2014-209727 are adopted in the present specification for reference. The TFT having the In-Ga-Zn-O-based semiconductor layer is preferably used as a driving TFT (for example, a TFT included in the driving circuit provided on the same substrate as the display region, in the vicinity of the display region including the plurality of pixels) and a pixel TFT (a TFT provided in the pixel) because of having a high mobility (exceeding 20 times that of a-SiTFT) and a low leak current (less than one hundredth than that of a-SiTFT).

The oxide semiconductor layer 14 may include an oxide semiconductor instead of an In-Ga-Zn-O-based semiconductor. For example, the oxide semiconductor layer 14 may include an In-Sn-Zn-O-based semiconductor (for example, In₂O₃—SnO₂—ZnO; InSnZnO). The In-Sn-Zn-O-based semiconductor is a ternary oxide of indium (In), tin (Sn), and zinc (Zn). Alternately, the oxide semiconductor layer 14 may include an In-Al-Zn-O-based semiconductor, an In-Al-Sn-Zn-O-based semiconductor, Zn-O-based semiconductor, an In-Zn-O-based semiconductor, Zn-Ti-O-based semiconductor, a Cd-Ge-O-based semiconductor, a Cd-Pb-O-based semiconductor, CdO (cadmium oxide), a Mg-Zn-O-based semiconductor, an In-Ga-Sn-O-based semiconductor, an In-Ga-O-based semiconductor, a Zr-In-Zn-O-based semiconductor, a Hf-In-Zn-O-based semiconductor, and the like.

The TFT 15 using the oxide semiconductor layer 14 as an active layer may be a “channel-etch. type TFT” of an “etching-stop type TFT”.

In the “channel-etch type TFT”, an etching-stop layer is not formed on a channel region, and a lower surface of an end of the source and drain electrodes on a channel side is disposed to be in contact with the upper surface of the oxide semiconductor layer. In the channel-etch type TFT, a conductive film for source and drain electrodes is formed on the oxide semiconductor layer and is formed by performing source and drain isolation. In a source and drain isolation step, a portion of a surface of the channel region may be etched.

On the other hand, in the TFT with the etching-stop layer formed on the channel region (etching-stop type TFT), the lower surface of the end of the source and drain electrodes on the channel side is positioned, for example, on the etching-stop layer. In the etching-stop type TFT, a conductive layer for source and drain electrodes is formed on the oxide semiconductor layer and the etching-stop Dyer and is formed by performing source and drain isolation, after forming the etching-stop layer covering a portion in the oxide semiconductor layer as a channel region, for example.

### [Another Configuration of TFT Substrate]

Hereinafter, another TFT substrate used in the liquid crystal display device according to embodiments of the present invention will be described with reference to the drawings. A TFT substrate described herein is an active matrix substrate including an oxide semiconductor TFT and a crystalline silicon TFT formed on a same substrate.

The active matrix substrate includes a TFT (pixel TFT) for each pixel. For example, the oxide semiconductor TFT having the In-Ga-Zn-O-based semiconductor film as an active layer is used as a pixel TFT.

A part or entire of the peripheral driving circuit is integrally formed on the pixel TFT and the same substrate. The active matrix substrate is so-called as a driver monolithic active matrix substrate. In the driver monolithic active matrix substrate, the peripheral driving circuit is provided in a region (non-display region or frame region) other than a region (display region) including the plurality of pixels. For example, the crystalline silicon TFT having a polycrystalline silicon film as an active layer is used as a TFT constituting the peripheral driving circuit (circuit TFT). When the oxide semiconductor TFT is used as a pixel TFT and the crystalline silicon TFT is used as a circuit TFT as described above, it is possible to suppress power consumption in the display region, and reduce the frame region.

Next, more specific configuration of the active matrix substrate including the oxide semiconductor TFT and the crystalline silicon TFT will be described with reference to the drawings.

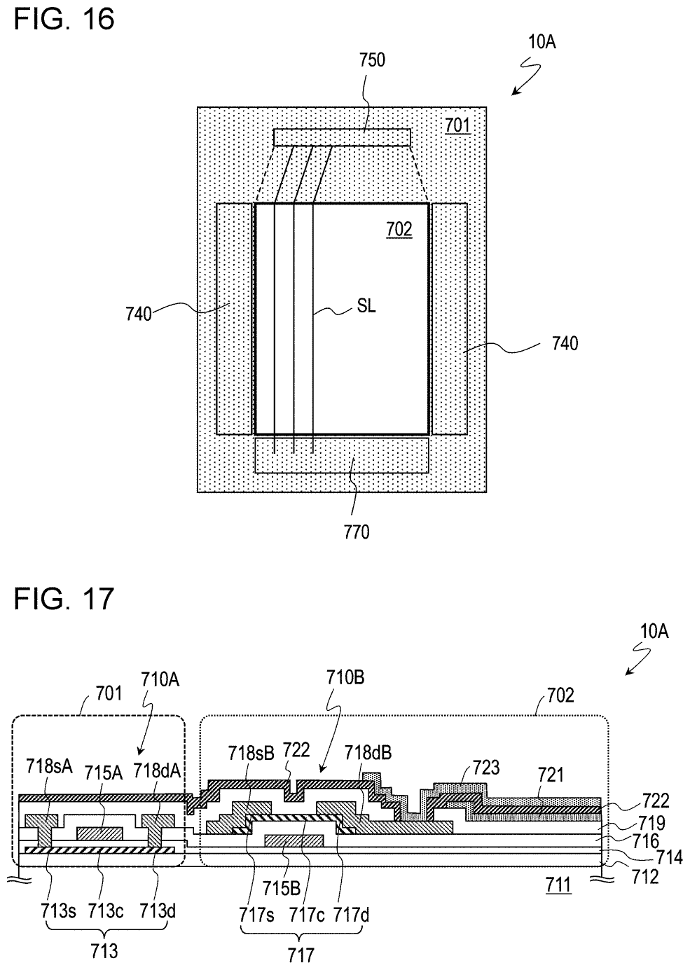

FIG. 16 is a view schematically illustrating an example of a planar structure of a TFT substrate 10A, and FIG. 17 is a cross-sectional view illustrating a cross section structure of a crystalline silicon TFT (hereinafter, referred to as “a first thin film transistor”) 710A and an oxide semiconductor TFT (hereinafter, referred to as a “second thin film transistor”) 710B in the TFT substrate 10A.

As illustrated in FIG. 16, the TFT substrate 10A has a display region 702 including a plurality of pixels and a region other than the display region 702 (non-display region). The non-display region includes a driving circuit formation region 701 provided with the driving circuit. For example, a gate driver circuit 740, an inspection circuit 770, and the like are provided in the driving circuit formation region 701. The plurality of gate bus lines (not illustrated) extending in a row direction and a plurality of source bus lines SL extending in a column direction are formed in the display region 702. Although not illustrated, each pixel is defined by, for example, the gate bus line and the source bus line SL. The gate bus lines are connected to terminals of the gate driver circuit, respectively. The source bus lines SL are connected to the terminals of a driver IC 750 mounted on the TFT substrate 10A, respectively.

As illustrated in FIG. 17, a second thin film transistor 710B is formed in the TFT substrate 102 as a pixel TFT in each pixel of the display region 702, and a first thin film transistor 710A is formed in the driving circuit formation region 701 as a circuit TFT.

The TFT substrate 10A includes a substrate 711, a base film 712 formed on a surface of the substrate 711, the first thin film transistor 710A formed on the base film 712, and the second thio film transistor 710E formed on the base film 712. The first thin film transistor 710A is a crystalline silicon TFT having an active region including crystalline silicon as a main component. The second thin film transistor 710B is an oxide semiconductor TFT having an active region including an oxide semiconductor as a main component. The first thio film transistor 710A and the second thin film transistor 710B are integrally constructed on the substrate 711. The “active region” used herein refers to a region in which a channel is formed in the semiconductor layer as an active layer of TFT.

The first thin film transistor 710A includes a crystalline silicon semiconductor layer (for example, a low-temperature polysilicon layer) 713 formed on the base film 712, a first insulating layer 714 covering the crystalline silicon semiconductor layer 713, and a gate electrode 715A provided on the first insulating layer 714. A portion located between the crystalline silicon semiconductor layer 713 and the gate electrode 715A in the first insulating layer 714 functions as a gate insulating film of the first thin film transistor 710A. The crystalline silicon semiconductor layer 713 has a region (active region) 713c formed with the channel and a source region 713s and a drain region 713d each located on both sides of the active region. In this example, in the crystalline silicon semiconductor layer 713, a portion overlapping the gate electrode 715A through the first insulating layer 714 is the active region 713c. In addition, the first thin film transistor 710A includes a source electrode 718sA and a drain electrode 718dA connected to the source region 713s and the drain region 713d, respectively. The source and drain electrodes 718sA and 718dA are provided on an interlayer insulating film covering the gate electrode 715A and the crystalline silicon semiconductor layer 713 (a second insulating layer 716), and connected to the crystalline silicon semiconductor layer 713 in a contact hole formed in the interlayer insulating film.

The second thin film transistor 710B includes a gate electrode 715B provided on the base film 712, the second insulating layer 716 covering the gate electrode 715B, and an oxide semiconductor layer 717 disposed on the second insulating layer 716. As illustrated, the first insulating layer 714 which is a gate insulating film of the first thin film transistor 710A may extend to a region so as to form the second thin film transistor 710B. In this case, the oxide semiconductor layer 717 is formed on the first insulating layer 714. A portion located between the gate electrode 715B and the oxide semiconductor layer 717 in the second insulating layer 716 functions as a gate insulating film of the second thin film transistor 710B. The oxide semiconductor layer 717 has a region (active region) 717c formed with the channel and a source contact region 717s and a drain contact region 717d each located on both sides of the active region. In this example, in the oxide semiconductor layer 717, a portion overlapping the gate electrode 715B through the second insulating layer 716 is an active region. 717c. In addition, the second thin film transistor 710B includes a source electrode 718sB and a drain electrode 718dB connected to the source contact region 717s and the drain contact region. 717d, respectively. Furthermore, a configuration in which the base film 712 is not provided on the substrate 711 is also possible.

The thin film transistors 710A and 710B are covered with a passivation film 719 in the second thin film transistor 710B functioning as a pixel TFT, the gate electrode 715B is connected to a gate bus line (not illustrated), the source electrode 718sB is connected to a source bus line (not illustrated), and the drain electrode 718dB is connected to a pixel electrode 723. In this example, the drain electrode 718dB is connected to the corresponding pixel electrode 723 in an opening portion formed in the passivation film 719. A video signal is supplied to the source electrode 718sB through the source bus line, and a charge necessary to the pixel electrode 723 is written on the basis of the gate signal from the gate bus line.

As illustrated, a transparent conductive layer 721 is formed on the passivation film 719 as a common electrode, and a third insulating layer 722 may be formed between the transparent conductive layer (common electrode) 721 and the pixel electrode 723. In this case, a slit-shaped or is provided in the pixel electrode 723. The TFT substrate 10A can be applied to, for example, an FFS mode display device. The FFS mode is a lateral electric field type mode in which a pair of electrodes are installed on one substrate and an electric field is applied to a direction parallel to a substrate surface (lateral direction) in the liquid crystal molecules. In this example, an electric field represented by an electric line of force is generated, the electric line of force coming out from the pixel electrode 723 and passing through a liquid crystal layer (not illustrated), and further coming out to the common electrode 721 through the slit-shaped opening of the pixel electrode 723. The electric field has a lateral component with respect to the liquid crystal layer. As a result, the lateral electric field can be applied to the liquid crystal layer. The lateral electric field type has an advantage in that a wide viewing angle can be realized as compared with the vertical electric field type since the liquid crystal molecules are not raised up from the substrate.

In addition, the thin film transistor 710B which is the oxide semiconductor TFT may be used as a TFT constituting the inspection circuit 770 (inspection TFT) as illustrated in FIG. 16.

Although not illustrated, an inspection TFT and the inspection circuit may be formed in, for example, a region mounted with the driver IC 750 as illustrated in FIG. 16. In this case, the inspection TFT is disposed between the driver IC 750 and the substrate 711.

In the illustrated example, the first thin film transistor 710A has a top gate structure in which the crystalline silicon semiconductor layer 713 is disposed between the gate electrode 715A and the substrate 711 (base film 712). On the other hand, the second thin film transistor 710B has a bottom gate structure in which the pate electrode 715B is disposed between the oxide semiconductor layer 717 and the substrate 711 (base film 712). By adopting such a structure, it is possible to more effectively suppress an increase in a manufacturing process and manufacturing costs when two types of thin film transistors 710A and 710B are integrally formed on the same substrate 711.

The TFT structure of first thin film transistor 710A and the second thio film transistor 710B is not limited to the above. For example, these thin film transistors 710A and 710B may have the same TFT structure. Alternately, the first thin film transistor 710A may have the bottom gate structure, and the second thin film transistor 710B may have the top gate structure. In addition, in a case of the bottom gate structure, a channel-etch type may be used as the thin film transistor 710B, and an etching-stop type may be used. In addition, the source electrode and the drain electrode may be a bottom contact type located below the semiconductor layer.

The second insulating layer 716 which is a gate insulating film of the second thin film transistor 710B may extend to a region formed with the first thin film transistor 710A and may function as an interlayer insulating film covering the gate electrode 715A of the first thin film transistor 710A and the crystalline silicon semiconductor layer 713. Thus, when the interlayer insulating film of the first thin film transistor 710A and the gate insulating film of the second thin film transistor 710B are formed in the same layer (the second insulating layer) 716, the second insulating layer 716 may have a laminated structure. For example, the second insulating layer 716 may have a laminated structure including a hydrogen donating layer capable of supplying hydrogen (for example, a silicon nitride layer) and an oxygen donating layer disposed on the hydrogen donating layer and capable of supplying oxygen (for example, a silicon oxide layer).

The gate electrode 715A of first thin film transistor 710A and the gate electrode 715B of the second thin film transistor 710B may be formed in the same layer. In addition, the source and drain electrodes 718sA and 718dA of first thin film transistor 710A and the source and drain electrodes 718sB and 718dB of the second thin film transistor 710B may be formed in the same layer. The expression “formed in the same layer” means that “formed using the same film (conductive film)”. Therefore, an increase in a manufacturing process and manufacturing costs can be suppressed.

### INDUSTRIAL APPLICABILITY

According to the embodiment of the present invention, the liquid crystal display device can suppress degradation in the display quality due to the partially peeling-off of the alignment film by the columnar spacer while suppressing reduction of the opening ratio. The embodiments of the present invention are preferably used for, for example, a high-definition liquid crystal display device.

### REFERENCE SIGNS LIST

10, 10A TFT substrate

11 SUBSTRATE

12 FIRST CONDUCTIVE LAYER

12g GATE ELECTRODE

13 GATE INSULATING LAYER

14 SEMICONDUCTOR LAYER

16 SECOND CONDUCTIVE LAYER

16s SOURCE ELECTRODE

17 INTERLAYER INSULATING LAYER

18 FIRST TRANSPARENT CONDUCTIVE LAYER

18a FIRST TRANSPARENT ELECTRODE (PIXEL ELECTRODE)

18d DRAIN ELECTRODE

19 INORGANIC INSULATING LAYER

20 SECOND TRANSPARENT CONDUCTIVE LAYER (COMMON ELECTRODE)

20s SLIT

21 INSULATING LAYER

22 THIRD CONDUCTIVE LAYER.

28 LIGHT SHIELDING LAYER

29 ALIGNMENT FILM

30 COUNTER SUBSTRATE

32 LIGHT SHIELDING LAYER (BLACK MATRIX)

33 COLOR FILTER LAYER

39 ALIGNMENT FILM

40 COLUMNAR SPACER

40a FIRST COLUMNAR SPACER

40b SECOND COLUMNAR SPACER

50 LIQUID CRYSTAL LAYER

100A, 100B, 100C, 100D LIQUID CRYSTAL DISPLAY DEVICE

100E, 100F, 100G LIQUID CRYSTAL DISPLAY DEVICE

GL GATE BUS LINE

R1, R2 PROJECTION

SL SOURCE BUS LINE

1. A liquid crystal display device, comprising:
a TFT substrate;
a counter substrate provided opposite to the TFT substrate;
a liquid crystal layer provided between the TFT substrate and the counter substrate; and
a plurality of pixels arranged in a matrix shape having a plurality of rows and a plurality of columns,
wherein the TFT substrate includes a TFT provided in each of the plurality of pixels, a plurality of gate bus lines extending in a first direction, and a plurality of source bus lines extending in a second direction different from the first direction,
the counter substrate includes a plurality of columnar spacers defining a thickness of the liquid crystal layer,
a surface of the TFT substrate on the liquid crystal layer side includes
a plurality of first projections overlapping the plurality of gate bus lines to extend in the first direction and protruding toward the liquid crystal layer, and
a plurality of second projections overlapping the plurality of source bus lines to extend in the second direction and protruding toward the liquid crystal layer, and
the plurality of columnar spacers include a first columnar spacer supporting at least two projections among the plurality of first projections or at least two projections among the plurality of second projections on a top surface.

2. The liquid crystal display device according to claim 1,
wherein a width of the top surface of the first columnar spacer is larger than a width of a recess formed between mutually adjacent projections among the at least two projections, in a direction perpendicular to a direction in which the at least two projections extend.

3. The liquid crystal display device according to claim 1,
wherein a width of the top surface of the first columnar spacer is larger than a pixel pitch in the plurality of pixels in a direction perpendicular to a direction in which the at least two projections extend.

4. The liquid crystal display device according to claim 1,
wherein the top surface of the first columnar spacer covers the at least two projections in a cross section perpendicular to a direction in which the at least two projections extend.

5. The liquid crystal display device according to claim 1,
wherein the plurality of columnar spacers further includes a second columnar spacer overlapping at least two of the plurality of gate bus lines or at least two of the plurality of source bus lines and not being in contact with the TFT substrate, when viewed from a normal direction of the TFT substrate.

6. The liquid crystal display device according to any one of claim 1,
wherein the TFT substrate includes
a substrate,
a first conductive layer supported by the substrate and including a gate electrode of the TFT and the plurality of gate bus lines,
a second conductive layer supported by the substrate and including a source electrode of the TFT and the plurality of source bus lines,
a gate insulating layer formed between the first conductive layer and the second conductive layer,
a semiconductor layer of the TFT,
an interlayer insulating layer formed on the first conductive layer, the second conductive layer, and the semiconductor layer,
a first, transparent conductive layer formed on the interlayer insulating layer,
an inorganic insulating layer formed on the first transparent conductive layer, and
a second transparent conductive layer formed on the inorganic insulating layer, and the interlayer insulating layer does not include an organic insulating layer.

7. The liquid crystal display device according to claim 6,
wherein the TFT substrate includes the first conductive layer and the second conductive layer in a region overlapping the at least two projections.

8. The liquid crystal display device according to claim 6,
wherein the TFT substrate includes a region not having the interlayer insulating layer between mutually adjacent projections among the at least two projections.

9. The liquid crystal display device according to claim 6, wherein the TFT substrate further includes a light shielding layer formed on the interlayer insulating layer in a region overlapping the at least two projections.

10. The liquid crystal display device according to claim 9,
wherein the light shielding layer is formed on the second transparent conductive layer so as to be in contact with the second transparent conductive layer.

11. The liquid crystal display device according to claim 6,
wherein the TFT substrate further includes a third conductive layer formed on the interlayer insulating layer in a region overlapping the at least two projections.

12. The liquid crystal display device according to claim 11,
wherein the third conductive layer is formed on the second transparent conductive layer through an insulating layer.

13. The liquid crystal display device according to claim 6,
wherein the first transparent conductive layer includes a pixel electrode provided in each of the plurality of pixels and electrically connected to a drain electrode of the TFT.

14. The liquid crystal display device according to claim 13,
wherein the drain electrode is included in the first transparent conductive layer.

15. The liquid crystal display device according to claim 6,
wherein the semiconductor layer includes an oxide semiconductor.

16. The liquid crystal display device according to claim 6,
wherein the semiconductor layer includes an In-Ga-Zn-O-based semiconductor.

17. The liquid crystal display device according to claim 16,
wherein the In-Ga-Zn-O-based semiconductor includes a crystalline portion.

18. The liquid crystal display device according to claim 6.
wherein the semiconductor layer has a laminated structure.
